(19) United States
(12) Patent Application Publication
(10) Pub. No.: US 2017/0372366 A1
(43) Pub. Date: Dec. 28, 2017

(54) COMMUNICATION SESSION BASED EVENT DRIVEN COMMUNICATION MANAGEMENT

(71) Applicant: Futurewei Technologies, Inc., Plano, TX (US)

(72) Inventor: Maohua Wei, Santa Clara, CA (US)

(21) Appl. No.: 15/190,822

(22) Filed: Jun. 23, 2016

(51) Int. Cl. G06Q 30/02; G06Q 50/00

(52) U.S. Cl. CPC G06Q 30/0267; G06Q 30/0255; G06Q 50/01

(57) ABSTRACT

A method includes detecting, via a server, a beginning of a communication session between multiple electronically connected users, initiating transfer, via the server, of multiple messages between the users, at least one message effecting a transfer of a random numerical value to a temporary pool of a first user to add to a total numerical value in the first user temporary pool, responsive to a change in the total numerical value in the first user temporary pool during the communication session, obtaining, via the server, a list of numerical values corresponding to digital content, at least one such digital content comprising a key communication offering the digital content in exchange for a first numerical value, comparing, via the server, the total numerical value in the first user temporary pool to the first numerical value, and initiating sending, via the server, the key communication to the first user if the total numerical value in the first user temporary pool is equal to or greater than the first numerical value.

### FIELD OF THE INVENTION

The present disclosure is related to communication management, and in particular to communication session based event driven communication management.

### BACKGROUND

Content, including advertising may be sent to users of computing devices based on knowledge of the user's interest, such as gender, age, religion, hobbies, and financial situation. Such factors are part of a context for the user and may also include web viewing history, payment history, past purchase, and other potentially relevant factors. One factor is whether or not the user has enough money to purchase the goods or services being advertised. While some users may have a sufficient account balance, they may not be willing to pay for goods or services.

Users of mobile devices may be subjected to targeted advertising that is a function of what the user can afford, to increase the likelihood of users responding and making a purchase responsive to receipt of the targeted advertising. Pre-paid credit available to a user may be used to identify advertisements for goods and services that the user cannot afford, and prevent such advertisements from being presented to the user.

### SUMMARY

A method includes detecting, via a server, a beginning of a communication session between multiple electronically connected users, initiating transfer, via the server, of multiple messages between the users, at least one message effecting a transfer of a random numerical value to a temporary pool of a first user to add to a total numerical value in the first user temporary pool, responsive to a change in the total numerical value in the first user temporary pool during the communication session, obtaining, via the server, a list of numerical values corresponding to digital content, at least one such digital content comprising a key communication offering the digital content in exchange for a first numerical value, comparing, via the server, the total numerical value in the first user temporary pool to the first numerical value, and initiating sending, via the server, the key communication to the first user if the total numerical value in the first user temporary pool is equal to or greater than the first numerical value.

A method includes tracking, via a server, receipt of random numerical values obtained by a user over a specified period of time, maintaining a summary numerical value representing a sum of the random numerical values obtained by the user, in response to receiving a request that includes an additional random numerical value via a user device of the user, querying a content store based on a combined numerical value of the additional random numerical value and the summary numerical value, wherein the content store includes multiple contents, each content having an associated content numerical value, in response to receiving a content from the content store, sending the content to the user device, wherein the content is associated with a content numerical value no greater than the combined numerical value, and wherein the content is sent substantially simultaneously to receiving the request, and updating the summary numerical value with the combined value minus the associated content numerical value associated with the sent content.

A device includes a processor and a memory device coupled to the processor and having a program stored thereon for execution by the processor to cause the processor to perform operations. The operations include detecting, via a server, a beginning of a communication session between multiple electronically connected users, initiating transfer, via the server, multiple messages between the users, at least one message effecting a transfer of a numerical value to a temporary pool of a first user to add to a total numerical value in the first user temporary pool, responsive to a change in the total numerical value in the first user temporary pool during the communication session, obtaining, via the server, a list of numerical values corresponding to digital content, at least one such digital content comprising a key communication offering the digital content in exchange for a first numerical value, comparing, via the server, the total numerical value in the first user temporary pool to the first numerical value, and initiating sending, via the server, the key communication to the first user if the total numerical value in the first user temporary pool is equal to or greater than the first numerical value.

### BRIEF DESCRIPTION OF THE DRAWINGS

FIG. 1 is a block diagram illustrating a system for managing communications and distributing content according to an example embodiment.

FIG. 2 is a flowchart illustrating a method of managing communications during a communication session according to an example embodiment.

FIG. 3 is a flowchart illustrating an alternative method of managing communications during a communication session according to an example embodiment.

FIG. 4 is a flowchart illustrating a further method of managing communications during a communication session with a social network group to an example embodiment.

FIG. 5 is a flowchart illustrating yet a further method of managing communications during a communication session with a social network group according to an example embodiment.

FIG. 6 is a flowchart illustrating a further alternative method of managing communications for a group of users according to an example embodiment.

FIG. 7 is a flowchart of a method of detecting a communication session time period according to an example embodiment.

FIG. 8 is a table illustrating numerical values for content according to an example embodiment.

FIG. 9 is a table illustrating numerical values in the temporary pool of each user, labeled A through L according to an example embodiment.

FIG. 10 is a table illustrating numerical values for a second example according to an example embodiment.

FIG. 11 is a table illustrating numerical values for a third example according to an example embodiment.

FIG. 12 is a flowchart illustrating a method of dynamically pushing content triggered by value received during a communication session according to an example embodiment.

FIG. 13A is a screen shot illustrating a user interface for interaction with a lucky money system according to an example embodiment.

FIG. 13B is a screen shot illustrating a user interface for interaction with a red envelope received from the lucky money system according to an example embodiment.

FIG. 13C is a screen shot illustrating a user interface illustrating the contents of a red envelope from a lucky money system according to an example embodiment.

FIG. 13D is a screen shot illustrating an advertisement sent to a user based on interaction with a lucky money system according to an example embodiment.

FIG. 14 is a block schematic diagram of a computer system to perform operations according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

While current solutions regarding targeted advertising take the ability of a user to pay into account, such solutions do not determine an amount that the user is willing to pay. Various embodiments of the current inventive subject matter utilize accounting systems, social media systems, and a communications management system to track increases in a user's account to identify amounts that a user might be willing to pay for goods and services. Such amounts are correlated with content related to such goods and services and offers for goods and services are optimized based on the amount the user more likely willing to pay. Since the offers are based on amounts the user is more likely willing to pay, advertising may be more effective than prior methods of selecting advertising based on ability to pay.

In some embodiments, the increases in the account are the result of unexpected winnings, such as from gambling, lucky money, and other sources which induce a psychological state more conducive to making purchases close to the increase. The increase may result in an immediate offer if it corresponds to an amount for key content, which is likely a highest value offer.

One technical problem involves the ability to monitor communications and track when users receive amounts, as well as to track a period corresponding to the communications. To solve the technical problem, the communication management system monitors communications, receives notifications when account balances change, and keeps track of a period corresponding to a communication session occurring in a social media setting. Such tracking and interfacing with multiple different systems can be a technical challenge, which the inventors have solved. The increases in the account may be tracked during a communication session between a group of users utilizing one of many social media services. The session may begin when a first communication in the group occurs that creates an increase in at least one user's account. If at the end of the session, increases in accounts do not result in a key amount, users may be provided content corresponding to the amount their account increased.

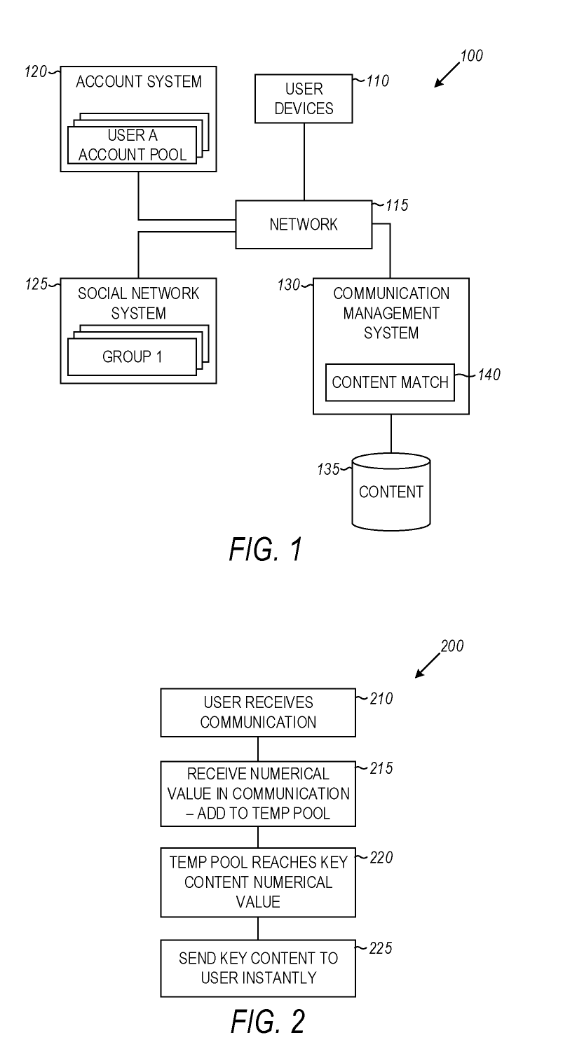

FIG. 1 is a block diagram illustrating a system 100 for managing communications and distributing content according to an example embodiment. User devices 110 are shown connected to a network. User devices 110 may be computers such as laptops, smart phones, tablets, or other devices that may be used to send and receive communications and connect to other devices via network 115. The network may be the internet, a private network, cell phone voice and data network, or other type of network that facilitates transfer of information between devices.

An account system 120 is coupled to the network and may be linked to one or more bank accounts of the users 110. The linking to bank accounts may include use of a link and credentials provided by a user in order to obtain financial information about the users indicative of their ability to pay for goods and services. In some embodiments, the account system 120 may query a user for balance information without the need to access user accounts at financial institutions. Different account systems may provide account management services for different users and are simply represented as account system 120. The account system 120 includes an account for each user with at least one base account numerical value and a temporary pool holding a numerical value, such as a currency amount corresponding to amounts received during one or more communication sessions with other users.

A social network system 125 may facilitate communications between one or more different groups of users. The group may be specified by a distribution list that identifies addresses for electronic communication between users in the group. Examples of social network system 125 include but are not limited to Facebook®, LinkedIn®, Twitter, Xing, Renren, Snapchat, Tumblr, Instagram, and others.

A communication management system 130 is also coupled to the network to generate amounts to transfer between users 110, to retrieve content 135, and match the content as indicated at content match 140 to amounts received by users during one or more communication sessions. In one embodiment, the communication management system 130 receives an amount from a first user, such as from the user's base account in account system 120. The amount is broken up into multiple “lucky money” communications, and sent via communications to other users in the group by use of the social network system 125. The system 130 may initiate the sending of such communications, which may be done by system 130 or by social network system 125 in various embodiment. The amounts may be random, adding up to the amount selected by the first user. The first communication initiated or detected may start the session. The communication may take the form of emails, instant messages, or other forms of communications that are directed to individual users in the group. Detection may take the form of noting initiation of a communication transferring value, or receipt from a social network service that such a communication has occurred. In some embodiments, the detection may occur upon a user opening the communication and accepting the amount, such that further operations, including the sending of content may be done contemporaneously with the user understanding that amounts were received.

The communication management system 130 may also read the temporary pools of user accounts from the account system in some embodiments in order to match content at 140. During the communication session, other users may also decide to transfer amounts to other users. The amounts transferred are tracked via the temporary pools in account system 120 and used to content match at 140 during the communication session, or immediately following the session in further embodiments. The content that is matched may be sent via the communications management system 135 or initiated for sending by another system, such as social network system 125.

In various embodiments, the systems may be separate networked systems, cloud based systems, or may be a single system implementing the various operations performed by the systems shown in FIG. 1. In one embodiment, a single server, or cloud based server utilizing one or more processors may perform the operations.

FIG. 2 is a flowchart illustrating a method 200 of managing communications during a communication session. At 210, a user receives a communication from another user in a group of users. The communication, when opened, may indicate that the user has received a numerical value. The user may accept the numerical value in one embodiment, whereupon the numerical value will be added to the user's temporary pool at 215. The temporary pool reflects the sum of values received during one or more communication sessions. At 220, the temporary pool reaches a key content numerical value. Upon reaching the key content numerical value, the key content is instantly sent to the user at 225. The term “instantly” is used to indicate that the key content is quickly sent while the user is still feeling lucky. Typical time frames range to as quickly as possible, such as within one, two, three, four, or five seconds following reaching the key content numerical value, or within a minute or two in further embodiments. The key content may include an offer to purchase goods or services corresponding to the key content numerical value. In one embodiment, the key content numerical value is the highest numerical value of all available content, or is simply identified as the key content. In some embodiments, the content may be limited to content values that individual users can afford given their overall ability to pay.

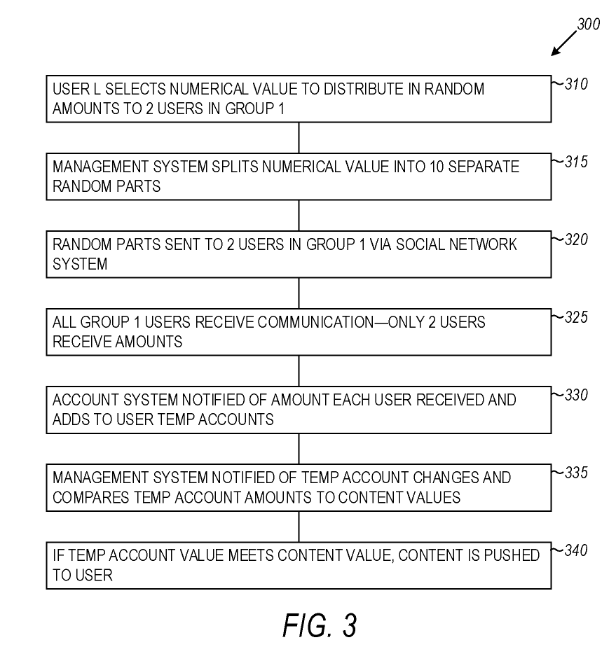

FIG. 3 is a flowchart illustrating an alternative method 300 of managing communications during a communication session. To begin a communication session at 310, a user L from a group of users, referred to as group 1, selects a numerical value to distribute in random amounts to Z users in the group 1. The communications management system at 315, such as a lucky money system, splits the numerical value into Z separate random parts that add up to the numerical value. Note that Z may be equal to or less than the number of users in group 1. At 320, the random parts are sent to Z users in the group via the social network system. All group 1 users receive a communication, however, only Z users actually receive a communication indicating they received amounts. Other users in the group may also receive a message indicating that lucky money has been sent, but their message may indicate that they did not receive an amount from the current distribution. Better luck next time.

At 330, the account system is notified of the amount each user received and that amount is added to respective user temporary accounts, which are indicative of amounts received during this and optionally other communication sessions. At 335, the management system is notified of the temporary account changes and compares the temporary account amounts to content values. At 340, if the temporary account value of one or more users meets the content value, the content is pushed to such users.

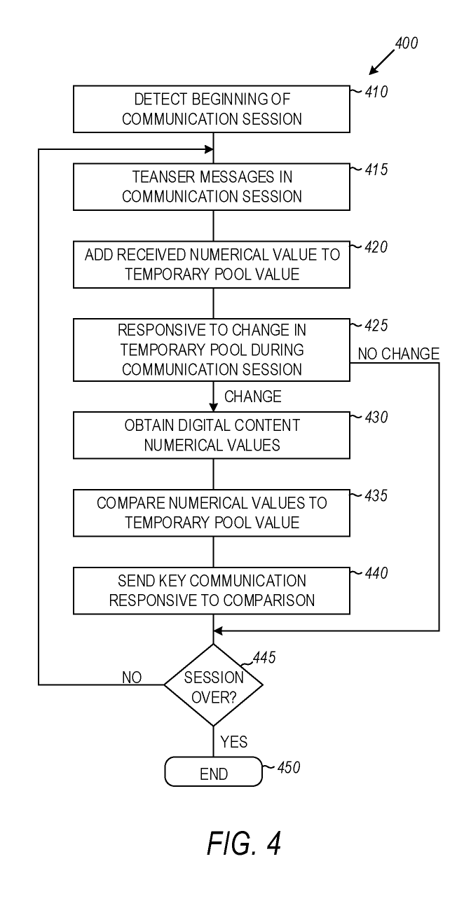

FIG. 4 is a flowchart illustrating a further method 400 of managing communications during a communication session with a social network group. At 410, the beginning of a communication session is detected. At 415, communications, such as messages with numerical values, such as lucky money amounts, are transferred during the communication session. The communication session may be detected as beginning when the first such message is transferred, and may run for 15 to 20 minutes in one embodiment. In further embodiments, the communication session may continue until 15 to 20 minutes following the last message with numerical values to be transferred.

At 420, received numerical values are added to each user's corresponding temporary pool value. The temporary pool value may contain an initial value from one or more communication sessions, which may occur prior to or during the current communication session. A user may participate in multiple temporally overlapping communication sessions in some embodiments, receiving numerical values in one or more of such sessions that are added to their temporary pool.

At 425, a change in the temporary pool of each user may be observed. Responsive to a change occurring, meaning an increase in one embodiment, digital content values are obtained at 430 and compared at 435 to the temporary pool values. Responsive to the comparison at 435, a key content communication may be sent to users having a changed temporary pool with a value meeting or exceeding the value of the key content at 440.

If no change is observed at 425, the method proceeds to determine whether or not the session is over at 445. The determination is also performed if a change occurred after operation 440. If the session is over as indicated at 445, the method ends at 450. If the session is not over, method 410 continues at 415, processing further transferred messages.

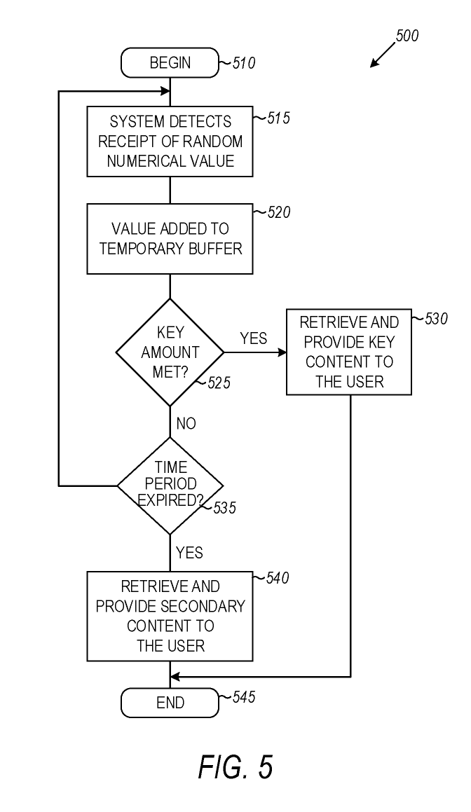

FIG. 5 is a flowchart illustrating yet a further method 500 of managing communications during a communication session with a social network group. At 510, method 500 begins. A system implementing the method detects at 515 a communication of a random numerical value within a group of users. At 520, the random value is added to a temporary buffer or pool. A check is made to determine whether a key amount has been met in the temporary pool responsive to the added value. If yes, key content corresponding to the key amount is retrieved and provided to the user whose temporary pool change met or exceeded the key amount.

If the key amount has not been met at 525, a check is made at 535 to determine whether a time period has expired, indicating a communication session has ended. If the session has not ended, the method returns to operation 515 and waits for detection of another random numerical value. If the time period has expired, the method retrieves and provides secondary content to the user based on the corresponding numerical values of the secondary content and the user's temporary buffer numerical value and the method ends at 545.

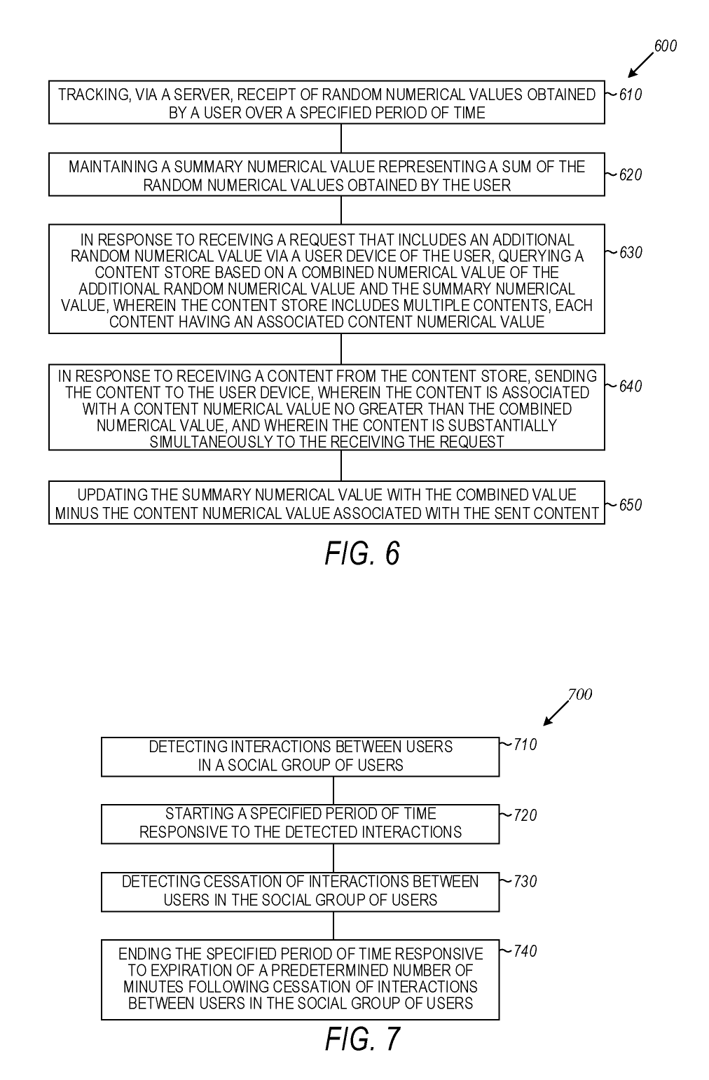

FIG. 6 is a flowchart illustrating a further alternative method 600 of managing communications for a group of users. At 610 the method tracks, via a server, receipt of random numerical values obtained by a user over a specified period of time. A summary numerical value representing a sum of the random numerical values obtained by the user is maintained at 620. In response to receiving a request at 630 that includes an additional random numerical value via a user device of the user, querying a content store based on a combined numerical value of the additional random numerical value and the summary numerical value. The content store may include multiple contents, each content having an associated content numerical value.

In response to receiving a content from the content store, sending the content to the user device at 640. The content is associated with a content numerical value no greater than the combined numerical value and may be sent substantially simultaneously to receiving the request. At 650, the summary numerical value is updated with the combined value minus the content numerical value associated with the sent content.

FIG. 7 is a flowchart of a method 700 of detecting a communication session time period. At 710, the method begins by detecting an interaction between users in a social group of users. The interaction may be a first transfer of values between users in one embodiment. In further embodiments, the interaction may be beginning a game, such as a gambling game between a group of users where values are transferred between users. One such game may include a poker game with wagering, or some other competitive game. Another interaction may include the use of a lucky money system where users designate an amount to randomly divide and transfer between multiple users in the group. The group may be a simple distribution list related to an email or messaging program, or may include one or more of multiple different social media services as described above.

At 720, a specified period of time is started responsive to the detected interactions. At 730, a last detected interaction may be detected. The last interaction may be used to start a timer at 740. The timer counts for a predetermined number of minutes following the last detected interaction, and ends the communication session following expiration of the timer. Note that the last detected interaction may be the first interaction in some embodiments where no further communications are detected. The last detected interaction may restart the timer each time an interaction is detected prior to expiration of the timer. In various embodiments, the predetermined number of minutes may be between 15 and 20 minutes. Shorter or longer periods may be utilized in further embodiments.

FIG. 8 is a table 800 illustrating numerical values for content. The table 800 includes three columns in one embodiment, with content listed in a first column at 810 as content 1-N. A numerical value is listed in a second column 820 for each content. A third column, referred to as a priority column 830 indicates which content is key content, and which, are secondary content. In one embodiment, the key content is content 1 with a numerical value of 50. Secondary content includes content 2 with a value of 10, content 3 with a value of 5 and content N with a value of 1. These content and values will be used in succeeding examples that illustrate the content that is distributed to one or more users based on changes to their corresponding temporary pool.

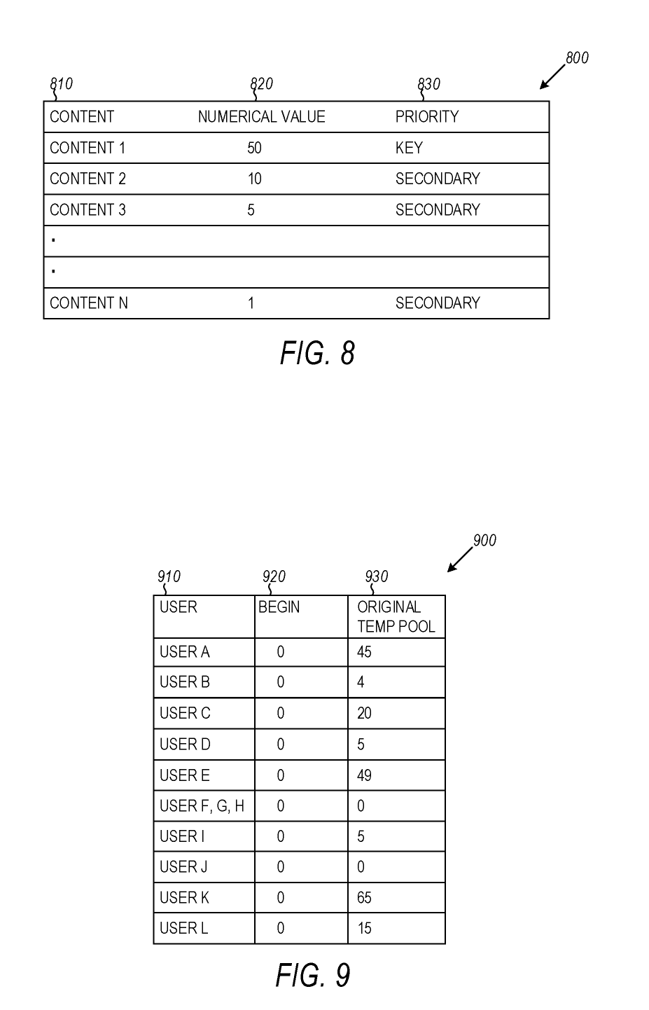

FIG. 9 is a table 900 illustrating numerical values in the temporary pool of each user 910, labeled A through L. A beginning value column 920 shows that each user began with a zero balance. After one or more communication sessions, a third column 930 indicate the value accumulated in the temp pool. In this example only user K reached, and in this case exceeded the key content numerical value of 50, with a value of 65. Thus, user K would be pushed the key content, corresponding to content 1 in FIG. 8.

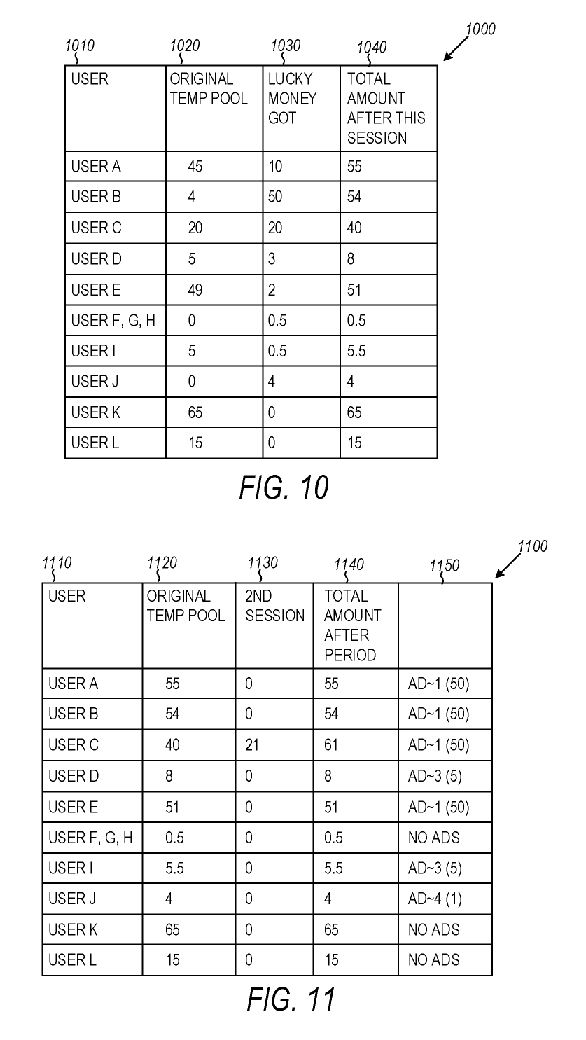

FIG. 10 is a table 1000 illustrating numerical values for a second example. A user column 1010 has the same users as in FIG. 9, and also has temporary pool values 1020 transferred over from FIG. 9. A column 1030 depicts values received during a current session, with all but users K and L receiving some values. Column 1040 indicates the total in the temporary pools for each user by the end of the current session, and may include amounts from one or more previous sessions.

During the current session, users A, B, and E each received amounts, and each exceeded the key amount of 50 corresponding to the key content. User A received 10, and with 45 in the temporary pool from previous sessions, ended up with 55. User B received the highest value of 50 and has a total pool amount of 54. User E only received 2, but had a high original temporary pool amount of 49, so ended with 51. The other users will not be pushed key content for various reasons, mostly because they did not receive enough value in the current session to have their totals exceed 50. User K is a special case in that their total is 65, which exceeds the key value, but they did not receive any value during the current session and so may not be emotionally disposed to making a purchase of goods or services associated with the key content even though they can clearly afford to make such a purchase.

FIG. 11 is a table 1100 illustrating numerical values for a third example. A user column 1110 has the same users as in FIGS. 9 and 10, and also has temporary pool values 1120 transferred over from FIG. 10, column 1040. A column 1130 depicts values received during a further distribution during the current session, with only user C receiving a value, which is 21 in this example Column 1140 indicates the total in the temporary pools for each user by the end of the current session, and includes amounts from one or more previous sessions.

A column 1150 indicates which content, in the form of an advertisement for goods or services at the value indicated, along with the associated value of the content. User C, upon receipt of the value from the further distribution during the communication session, now has more than the key value, and so may be instantly sent the key value content.

When the further distribution, referred to as a second session in one embodiment, ends, and after a period of time expires, such as 20 minutes later following no further activity, the communication session ends. The communication session may be referred to as a period session. In this period session, users A, B, C and E were delivered key content at the time they received their distributions of value. After the period session ends, user D, having received a total value of 8, may be delivered content referred to as ad 3 having a value of 5. User J ended with a value of 4, and will receive content ad 4 with a corresponding value of 1. Users F, G, H, K, and L will not be delivered ads, as they either received no values during the session, or their overall total values were less than any corresponding content values. Thus, content ad 2 will not be delivered in this third example.

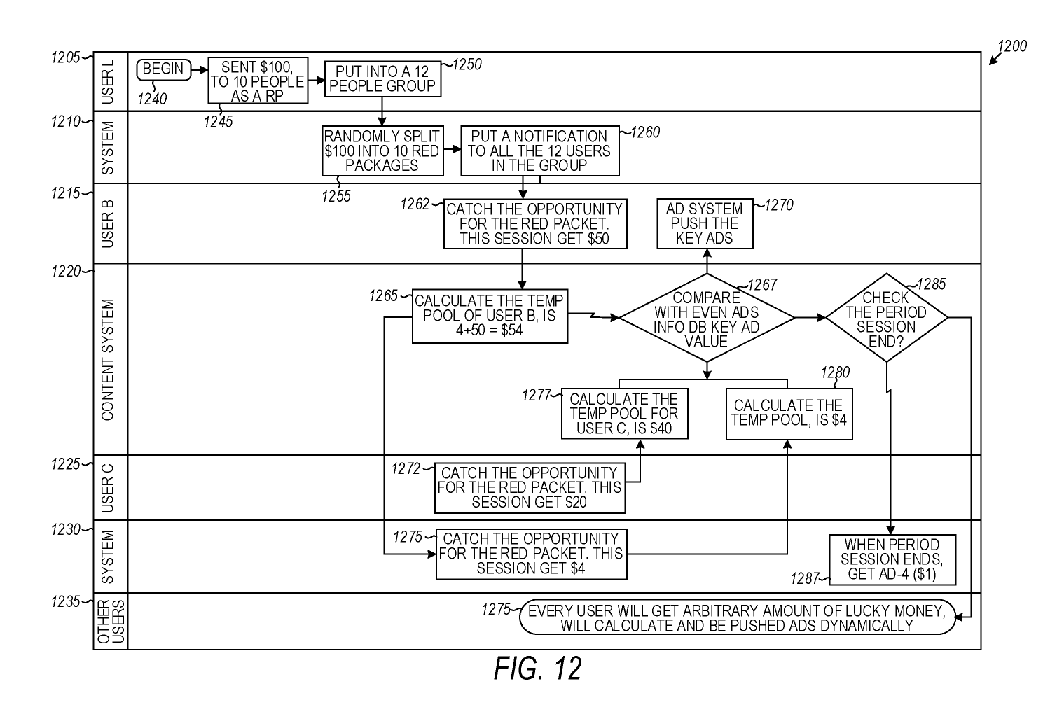

FIG. 12 is a flowchart illustrating a method 1200 of dynamically pushing content triggered by value received during a communication session according to an example embodiment. In one example, several operations may be performed or initiated by different entities indicated on the left side of the figure as user L at 1205, system 1210, user B at 1215, content system 1220, user C at 1225, user J at 1230, and other users at 1235. Method 1200 begins at 1240 with user L designated a value of 100 to send to 10 people at 1245 as random amounts. A group is selected at 1250 and in one embodiment, includes 12 people. The group may be a distribution list or some group associated with a social media service or application. A preexisting group may be selected, or one may be built from a contact list or manually entered in different embodiments.

The system 1210 receives the information selected by user L at 1255 and randomly splits the 100 value into 10 communications, referred to in a lucky money system as red packets or packages. A notification is sent at 1260 by system 1210 to the 12 users in the group. User B for example may catch an opportunity at 1262 in the form of receipt of the red packet, and in this example received a value of 50. The content system 1220 may then calculate at 1265 the temporary pool of user B as 4, the preexisting amount, plus the 50, for a total of 54. This calculation may trigger a comparison at 1267 by the content system to the key content value and result in the key content being pushed to user B at 1270.

At the same time, users C and J may also catch the opportunity for red packets at 1272 and 1275 receiving 20 and 4 respectively. Their temporary pools are also calculated as indicated at 1277 and 1280 and compared at 1267, resulting in user C receiving the key add. A check is then done at 1285 to determine if the session ended, and upon ending, user J receives the content ad 4 as indicated at 1287. As indicated at 1290, the other users receiving value during the session will also have their temporary pools calculated and be pushed corresponding content.

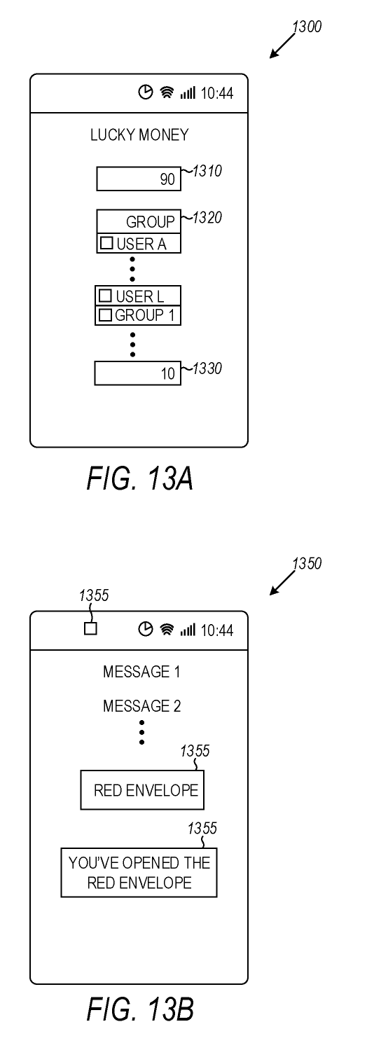

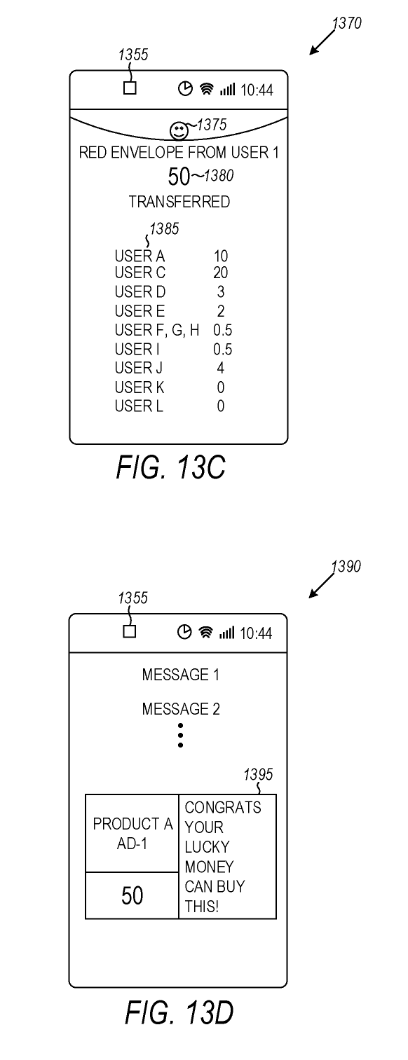

FIG. 13A is a screen shot 1300 illustrating a user interface for interaction with a lucky money system to randomly distribute money to multiple users in a selected group. A first field 1310 is provided to indicate an amount of money to transfer, such 90, which is for example, the sum of lucky money 1030 in FIG. 10. A second field 1320 is a group selector field, and may include a pulldown list of groups and individuals with checkboxes next to each in order to select one or more individuals and groups to which to send lucky money. A third field 1330 allows the user to select the number of people that should receive greater than zero amounts of random distributions. Consistent with FIG. 10, 10 of the 12 people selected in second field 1320 receive distributions. A send icon 1340 is selectable to initiate the transfer.

FIG. 13B is a screen shot 1350 of a first recipient user interface when receiving a communication regarding lucky money. A status icon 1355 may be provided at the top of the screen indicative of a “red envelope” or red packet having been received. The status icon may be colored red to draw attention to it. A list of communications, such as social media based communications includes an entry corresponding to the red envelope 1360, and may also contain the color red. A user may open the red envelope 1360, such as by selecting it via a user interface command, such as a touch, click, double click, enter key, or other means. Upon selecting it, a notice 1365 indicating the red envelope 1360 has been opened may occur below or otherwise near the red envelope.

FIG. 13C is a screen shot 1370 of an opened red envelope that provides details, such as an indication 1375 of who the red envelope is from, and an amount received at 1380. A list of other members of the group and the amounts they received may also be listed at 1385. If there was no money transferred by the red envelope, a message, such as “better luck next time” may be displayed. When the red envelope is opened at 1360, the temporary pool is updated with the amount received, and the system 130 is notified of the change in the temporary pool. In further embodiments, a further user interface element may be provided enabling the user to accept or reject the amount as an alternative to automatically accepting the amount upon opening the red envelope.

FIG. 13D is a screen shot 1390 illustrating a list of messages, where one of the messages is an advertisement 1395 selected and sent to the user based on the status of the temporary pool as described above. For examples users A, B, C, and E may each get an ad for a product or services that may be purchased for 50 based on such users having won an amount in the session and their temporary pool equaling or exceeding 50, again corresponding to FIG. 10.

In cases where a key content numerical value is reached during a session, as detected by the communication management system 130 reading the status of the temporary pool responsive to being notified of the change in the temporary pool, key content, such as advertisement 1395 is sent instantly to the user. The key content may be sent via the communication management system 130 quickly, while the user is still feeling lucky. Typical time frames range to as quickly as possible upon receipt and acceptance of the lucky money, such as within one, two, three, four, or five seconds following reaching the key content numerical value, or within a minute or two in further embodiments.

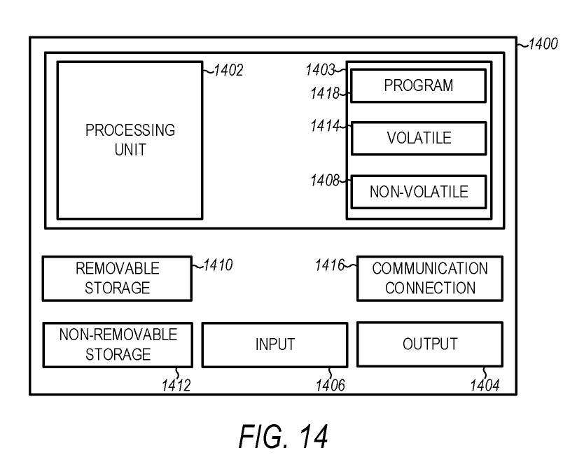

FIG. 14 is a block schematic diagram of a computer system 1400 to perform operations according to example embodiments. All components need not be used in various embodiments or for various systems that perform one or more of the operations. One example computing device in the form of a computer 1400, may include a processing unit 1402, memory 1403, removable storage 1410, and non-removable storage 1412. Although the example computing device is illustrated and described as computer 1400, the computing device may be in different forms in different embodiments, such as a server implemented by one or more processors or cloud based computing resources. The computing device may also be used to implement other devices, such as the user device which may include a smartphone, a tablet, smartwatch, or other computing device including the same or similar elements as illustrated and described with regard to FIG. 14. Devices such as smartphones, tablets, and smartwatches are generally collectively referred to as mobile devices. Further, although the various data storage elements are illustrated as part of the computer 1400, the storage may also or alternatively include cloud-based storage accessible via a network, such as the Internet.

Memory 1403 may include volatile memory 1414 and non-volatile memory 1408. Computer 1400 may include—or have access to a computing environment that includes—a variety of computer-readable media, such as volatile memory 1414 and non-volatile memory 1408, removable storage 1410 and non-removable storage 1412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

Computer 1400 may include or have access to a computing environment that includes input 1406, output 1404, and a communication connection 1416. Output 1404 may include a display device, such as a touchscreen, that also may serve as an input device. The input 1406 may include one or more of a touchscreen, touchpad, mouse, keyboard, camera, one or more device-specific buttons, one or more sensors integrated within or coupled via wired or wireless data connections to the computer 1400, and other input devices. The computer may operate in a networked environment using a communication connection to connect to one or more remote computers, such as database servers, including cloud based servers and storage. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable storage device are executable by the processing unit 1402 of the computer 1400. A hard drive, CD-ROM, and RAM are some examples of articles including a non-transitory computer-readable medium such as a storage device. The terms computer-readable medium and storage device do not include carrier waves. For example, a computer program 1418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 1400 to provide generic access controls in a COM based computer network system having multiple users and servers.

### Examples

1. In example 1, a method includes detecting, via a server, a beginning of a communication session between multiple electronically connected users, initiating transfer, via the server, of multiple messages between the users, at least one message effecting a transfer of a random numerical value to a temporary pool of a first user to add to a total numerical value in the first user temporary pool, responsive to a change in the total numerical value in the first user temporary pool during the communication session, obtaining, via the server, a list of numerical values corresponding to digital content, at least one such digital content comprising a key communication offering the digital content in exchange for a first numerical value, comparing, via the server, the total numerical value in the first user temporary pool to the first numerical value, and initiating sending, via the server, the key communication to the first user if the total numerical value in the first user temporary pool is equal to or greater than the first numerical value.

In one embodiment, detecting a beginning of a communication session may be performed by, for example, the communication management system 130 executing code to perform operation 410 in method 400 or operation 710 in method 700. Initiating transfer of messages may be performed by, for example, communication management system 130 in conjunction with social network system 125. The account system 120 may be used to provide the temporary pool. The digital content may be stored at 135. The communication management system 130 may also be programmed to perform the comparing operation and sending of the key communication or other content.

2. The method of example 1 and further comprising updating the total numerical value by subtracting the first numerical value responsive to sending the key communication. Example 2 may be performed for example by communication management system 130 performing operations indicated at 650.

3. The method of example 2 and further comprising detecting an end of the communication session, comparing the total numerical value in the temporary pools of each user responsive to detection of the end of the communication session, and initiating sending a communication having a highest numerical value equal to or less than the total numerical value in each temporary pool to each corresponding user. Example 3 may be performed for example by communication management system 130 performing operations indicated at 535, 540, 1285 and 1287.

4. The method of example 3 wherein the communication session is detected as ended responsive to a lack of further communications between the same group of multiple electronically connected users for a first period of time. Example 4 may be performed for example by communication management system 130 performing operations indicated at 445, 1285.

5. The method of example 4 wherein the first period of time is between 10 and 30 minutes.

6. The method of any of examples 3-5 wherein the communication session corresponds to a social network comprising the multiple electronically connected users. The social network is indicated for example at 125.

7. The method of any of examples 3-5 wherein the communication session corresponds to a distribution list. The distribution list is indicated for example at 1320.

8. The method of any of examples 1-7 wherein the beginning of the communication session is detected by detecting a communication to multiple users that contains random numerical values to be added to corresponding user's temporary pools. Example 8 may be performed for example by communication management system 130 performing operations indicated at 410. The random numerical values may be determined in accordance with method 300.

9. The method of any of examples 1-8 wherein the communication session is ended responsive to a lack of further communications between the same group of multiple electronically connected users for a first period of time. Example 9 may be performed for example by communication management system 130 performing operations indicated at 535.

10. The method of any of examples 1-9 wherein detecting the beginning of a communication session between multiple electronically connected users comprises detecting a lucky money communication directed to the multiple electronically connected users. Example 10 may be performed for example by communication management system 130 performing operations indicated at least at 410, 415, 515, 610, 710, 720, 1260, 1262, and 1355.

11. In example 11, a method comprises tracking, via a server, receipt of random numerical values obtained by a user over a specified period of time, maintaining a summary numerical value representing a sum of the random numerical values obtained by the user, in response to receiving a request that includes an additional random numerical value via a user device of the user, querying a content store based on a combined numerical value of the additional random numerical value and the summary numerical value, wherein the content store includes multiple contents, each content having an associated content numerical value, in response to receiving a content from the content store, sending the content to the user device, wherein the content is associated with a content numerical value no greater than the combined numerical value, and wherein the content is sent substantially simultaneously to receiving the request, and updating the summary numerical value with the combined value minus the associated content numerical value associated with the sent content.

In one embodiment, detecting a beginning of a communication session may be performed by, for example, the communication management system 130 executing code to perform operation 410 in method 400 or operation 710 in method 700. Initiating transfer of messages may be performed by, for example, communication management system 130 in conjunction with social network system 125. The account system 120 may be used to provide the temporary pool. The digital content may be stored at 135. The communication management system 130 may also be programmed to perform the comparing operation and sending of the key communication or other content.

12. The method of example 11 and further comprising detecting interactions between users in a social group of users, starting the specified period of time responsive to the detected interactions, detecting cessation of interactions between users in the social group of users, and ending the specified period of time responsive to expiration of a predetermined number of minutes following cessation of interactions between users in the social group of users.

13. The method of example 12 wherein the random numerical values comprise at least one of lucky money, lottery winning amounts, and gambling winning amounts.

14. The method of any of examples 12-13 wherein comparing the sum of the random numerical values to the values of the content is performed during the specified period of time and if the summed random numerical value is at least equal to the key content numerical value, distributing the key content to the user prior to expiration of the specified period of time.

15. The method of any of examples 12-14 wherein the specified period of time is between about ten and twenty minutes.

16. The method of any of examples 12-15 wherein the sum of the random numerical values is representative of a change in total numerical value in the temporary storage buffer during the specified period of time.

17. The method of any of examples 12-16 wherein the key content comprises an advertisement for a product, and wherein the associated numerical value is a price of the product, and wherein the secondary content comprises multiple advertisements for products having prices less than the key content value.

18. In example 18, a device comprises a processor and a memory device coupled to the processor and having a program stored thereon for execution by the processor to cause the processor to perform operations. The operations including detecting, via a server, a beginning of a communication session between multiple electronically connected users, initiating transfer, via the server, multiple messages between the users, at least one message effecting a transfer of a numerical value to a temporary pool of a first user to add to a total numerical value in the first user temporary pool, responsive to a change in the total numerical value in the first user temporary pool during the communication session, obtaining, via the server, a list of numerical values corresponding to digital content, at least one such digital content comprising a key communication offering the digital content in exchange for a first numerical value, comparing, via the server, the total numerical value in the first user temporary pool to the first numerical value, and initiating sending, via the server, the key communication to the first user if the total numerical value in the first user temporary pool is equal to or greater than the first numerical value.

In one embodiment, an example processor and memory are shown at least in FIG. 14 at 1402 and 1403, 1418, as well as represented by communication management system 130. Detecting a beginning of a communication session may be performed by, for example, the communication management system 130 executing code to perform operation 410 in method 400 or operation 710 in method 700. Initiating transfer of messages may be performed by, for example, communication management system 130 in conjunction with social network system 125. The account system 120 may be used to provide the temporary pool. The digital content may be stored at 135. The communication management system 130 may also be programmed to perform the comparing operation and sending of the key communication or other content.

19. The device of example 18 and further comprising updating the total numerical value by subtracting the first numerical value responsive to sending the key communication, detecting an end of the communication session, comparing the total numerical value in the temporary pools of each user responsive to detection of the end of the communication session, and sending a communication having a highest numerical value equal to or less than the total numerical value in each temporary pool to each corresponding user.

20. The device of example 19 wherein the communication session is detected as ended responsive to a lack of further communications between the same group of multiple electronically connected users for a first period of time, wherein the communication session corresponds to a social network comprising the multiple electronically connected users, and wherein the communication session corresponds to a distribution list.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
detecting, via a server, a beginning of a communication session between multiple electronically connected users;
initiating transfer, via the server, of multiple messages between the users, at least one message effecting a transfer of a random numerical value to a temporary pool of a first user to add to a total numerical value in the first user temporary pool; and
responsive to a change in the total numerical value in the first user temporary pool during the communication session:
obtaining, via the server, a list of numerical values corresponding to digital content, at least one such digital content comprising a key communication offering the digital content in exchange for a first numerical value;
comparing, via the server, the total numerical value in the first user temporary pool to the first numerical value; and
initiating sending, via the server, the key communication to the first user if the total numerical value in the first user temporary pool is equal to or greater than the first numerical value.

2. The method of claim 1 and further comprising updating the total numerical value by subtracting the first numerical value responsive to sending the key communication.

3. The method of claim 2 and further comprising:
detecting an end of the communication session;
comparing the total numerical value in the temporary pools of each user responsive to detection of the end of the communication session; and
initiating sending a communication having a highest numerical value equal to or less than the total numerical value in each temporary pool to each corresponding user.

4. The method of claim 3 wherein the communication session is detected as ended responsive to a lack of further communications between the same group of multiple electronically connected users for a first period of time.

5. The method of claim 4 wherein the first period of time is between ten and thirty minutes.

6. The method of claim 3 wherein the communication session corresponds to a social network comprising the multiple electronically connected users.

7. The method of claim 3 wherein the communication session corresponds to a distribution list.

8. The method of claim 1 wherein the beginning of the communication session is detected by detecting a communication to multiple users that contains random numerical values to be added to corresponding user's temporary pools.

9. The method of claim 1 wherein the communication session is ended responsive to a lack of further communications between the same group of multiple electronically connected users for a first period of time.

10. The method of claim 1 wherein detecting the beginning of a communication session between multiple electronically connected users comprises detecting a lucky money communication directed to the multiple electronically connected users.

11. A method comprising:
tracking, via a server, receipt of random numerical values obtained by a user over a specified period of time;
maintaining a summary numerical value representing a sum of the random numerical values obtained by the user;
in response to receiving a request that includes an additional random numerical value via a user device of the user, querying a content store based on a combined numerical value of the additional random numerical value and the summary numerical value, wherein the content store includes multiple contents, each content having an associated content numerical value;
in response to receiving a content from the content store, sending the content to the user device, wherein the content is associated with a content numerical value no greater than the combined numerical value, and wherein the content is sent substantially simultaneously to receiving the request; and
updating the summary numerical value with the combined value minus the associated content numerical value associated with the sent content.

12. The method of claim 11 and further comprising:
detecting interactions between users in a social group of users;
starting the specified period of time responsive to the detected interactions;
detecting cessation of interactions between users in the social group of users; and
ending the specified period of time responsive to expiration of a predetermined number of minutes following cessation of interactions between users in the social group of users.

13. The method of claim 12 wherein the random numerical values comprise at least one of lucky money, lottery winning amounts, and gambling winning amounts.

14. The method of claim 12 wherein comparing the sum of the random numerical values to the values of the content is performed during the specified period of time and if the summed random numerical value is at least equal to the key content numerical value, distributing the key content to the user prior to expiration of the specified period of time.

15. The method of claim 12 wherein the specified period of time is between about ten and twenty minutes.

16. The method of claim 12 wherein the sum of the random numerical values is representative of a change in total numerical value in the temporary storage buffer during the specified period of time.

17. The method of claim 12 wherein the key content comprises an advertisement for a product, and wherein the associated numerical value is a price of the product, and wherein the secondary content comprises multiple advertisements for products having prices less than the key content value.

18. A device comprising:
a processor; and
a memory device coupled to the processor and having a program stored thereon for execution by the processor to cause the processor to perform operations comprising:
detecting, via a server, a beginning of a communication session between multiple electronically connected users;
initiating transfer, via the server, multiple messages between the users, at least one message effecting a transfer of a numerical value to a temporary pool of a first user to add to a total numerical value in the first user temporary pool; and
responsive to a change in the total numerical value in the first user temporary pool during the communication session:
obtaining, via the server, a list of numerical values corresponding to digital content, at least one such digital content comprising a key communication offering the digital content in exchange for a first numerical value;
comparing, via the server, the total numerical value in the first user temporary pool to the first numerical value; and
initiating sending, via the server, the key communication to the first user if the total numerical value in the first user temporary pool is equal to or greater than the first numerical value.

19. The device of claim 18 and further comprising:
updating the total numerical value by subtracting the first numerical value responsive to sending the key communication;
detecting an end of the communication session;
comparing the total numerical value in the temporary pools of each user responsive to detection of the end of the communication session; and
sending a communication having a highest numerical value equal to or less than the total numerical value in each temporary pool to each corresponding user.

20. The device of claim 19 wherein the communication session is detected as ended responsive to a lack of further communications between the same group of multiple electronically connected users for a first period of time, wherein the communication session corresponds to a social network comprising the multiple electronically connected users, and wherein the communication session corresponds to a distribution list.
